(19) United States
(12) Patent Application Publication
(10) Pub. No.: US 2019/0344686 A1
(43) Pub. Date: Nov. 14, 2019

(54) REMOVABLE ROTATING SEATING SYSTEM

(71) Applicant: GM GLOBAL TECHNOLOGY OPERATIONS LLC, Detroit, MI (US)

(72) Inventors: Shaun P. Kavanagh, Clinton Township, MI (US); Stephen Rylance, Holly, MI (US)

(73) Assignee: GM GLOBAL TECHNOLOGY OPERATIONS LLC, Detroit, MI (US)

(21) Appl. No.: 15/979,048

(22) Filed: May 14, 2018

(51) Int. Cl. B60N 2/30

(52) U.S. Cl. CPC B60N 2/3097; B60N 2/3013; B60N 2/305

(57) ABSTRACT

In accordance with an exemplary embodiment, seating systems for platforms are provided. In one exemplary embodiment, the seating system includes a base component and a rotating component. The base component is fixed in position. The rotating component is configured to rotate between a first position, in which one or more occupants may sit on the seating system; and a second position, in which the rotating component may be readily removed from the seating system, without tools. The base component and the rotating have respective mating components forming one or more engagement systems that hold the rotating component into place when the rotating component is in the first position, and that allow removal of the rotating component when the rotating component is in the second position.

### TECHNICAL FIELD

The technical field generally relates to the field of vehicles and other mobile platforms and, more specifically, to seating systems for vehicles and other platforms.

### INTRODUCTION

Many vehicles and other platforms include seating systems. With certain types of vehicles and platforms, it may be desirable to easily remove the seating systems. This may be particularly important, for example, with respect to high-use vehicles and platforms such as taxi cabs, buses and/or bus stations, trains and/or train stations, and so on.

Accordingly, it is desirable to provide seating systems, for example for vehicle and/or other platforms, for example that are easily removed. Furthermore, other desirable features and characteristics of the present invention will become apparent from the subsequent detailed description and the appended claims, taken in conjunction with the accompanying drawings.

### SUMMARY

In accordance with an exemplary embodiment, a seating system is provided. The seating system includes a base component and a rotating component. The base component is fixed in position. The rotating component is configured to rotate between a first position, in which one or more occupants may sit on the seating system; and a second position, in which the rotating component may be readily removed from the seating system, without tools. The base component and the rotating have respective mating components forming one or more engagement systems that hold the rotating component into place when the rotating component is in the first position, and that allow removal of the rotating component when the rotating component is in the second position.

Also in one embodiment, the rotating component that is further configured to rotate to a third position, in which the rotating component is stowed; and the one or more engagement systems also hold the rotating component into place when the rotating component is in the third position.

Also in one embodiment, the second position includes an intermediate position between the first and third positions.

Also in one embodiment, the base component includes a protruding element and a latching mechanism; the rotating component includes a pivot element and a latchable element; the protruding element and the pivot element include first mating components that, together, form a first engagement system of the one or more engagement systems; and the latching mechanism and the latchable element include second mating component that, together, form a second engagement system of the one or more engagement systems.

Also in one embodiment, the rotating component further includes a seating region that is attached or otherwise coupled to the pivot element and the latchable element.

Also in one embodiment, the seating region includes a seating bench and a backrest that are attached or otherwise coupled to one another.

Also in one embodiment, the pivot element includes a cup-shaped element; the protruding element includes a pin; the latching mechanism includes a bracket with a claw; and the latchable element includes a rod.

Also in one embodiment, the seating system further includes a latch for the bracket that requires a mechanical means of release to adjust the seat to another one of the first, second, or third positions.

Also in one embodiment, the seating system is configured for installation within a vehicle.

In another exemplary embodiment, a seating system for installation within a platform is provided. The seating system includes a base component and a rotating component. The base component is fixed in position, and includes a latching mechanism and a protruding element. The rotating component is configured to rotate between: a seating position, in which one or more occupants may sit on the seating system; a stowed position, in which the rotating component is stowed; and an intermediate position, in which the rotating component may be readily removed from the seating system. The rotating component includes a seating region, a latchable element, and a pivot element. The latchable element is attached or otherwise coupled to the seating region. The pivot element that is attached or otherwise coupled to the seating region. The latching mechanism and the latchable element are mating components that, collectively, include a first engagement system that holds the rotating component into place when the rotating component is in the seating position and when the rotating component is in the stowed position. The pivot element and the protruding element are mating components that, collectively, include a second engagement system that also holds the rotating component into place when the rotating component is in the seating position and when the rotating component is in the stowed position.

Also in one embodiment, the seating region includes a seating bench and a backrest that are attached or otherwise coupled to one another. Also in one embodiment, the pivot element includes a cup-shaped element; the protruding element includes a pin; the latching mechanism includes a bracket with a claw; and the latchable element includes a rod.

Also in one embodiment, the seating system also includes a latch for the bracket that requires a mechanical means of release to adjust the seat to another one of the 3 positions.

Also in one embodiment, the seating system is configured for installation within a vehicle.

In another exemplary embodiment, a platform is provided. The platform includes a body and a seating system disposed within the body. The seating system includes a base component and a rotating component. The base component is fixed in position, and includes a latching mechanism and a protruding mechanism. The rotating component is configured to rotate between: a seating position, in which one or more occupants may sit on the seating system, a stowed position, in which the rotating component is stowed; and intermediate position, in which the rotating component may be readily removed from the seating system. The rotating component includes: a seating region; a latchable element that is attached or otherwise coupled to the seating region; and a pivot element that is attached or otherwise coupled to the seating region. The latching mechanism and the latchable element are mating components that, collectively, include a first engagement system that holds the rotating component into place when the rotating component is in the seating position and when the rotating component is in the stowed position. The pivot element and the protruding element are mating components that, collectively, include a second engagement system that also holds the rotating component into place when the rotating component is in the seating position and when the rotating component is in the stowed position.

Also in one embodiment, the seating region includes a seating bench and a backrest that are attached or otherwise coupled to one another.

Also in one embodiment, the pivot element includes a cup-shaped element; the protruding element includes a pin; the latching mechanism includes a bracket with a claw; and the latchable element includes a rod.

Also in one embodiment, the seating system includes a latch for the bracket that requires a tool for removal of the rotating component.

Also in one embodiment, the platform includes a mobile platform.

Also in one embodiment, the mobile platform includes an automotive vehicle.

### DESCRIPTION OF THE DRAWINGS

The present disclosure will hereinafter be described in conjunction with the following drawing figures, wherein like numerals denote like elements, and wherein:

FIG. 1 is a functional block diagram of a vehicle that includes a seating system that includes a base component and a rotating component that is rotatable and readily removed without tools when rotated to a certain angle, for example for removal from a vehicle or other platform, in accordance with exemplary embodiments; and

FIG. 2 is a side view seating system of FIG. 1, in accordance with exemplary embodiments;

FIG. 3 is an isometric view of a front side of the seating system of FIG. 1, in accordance with exemplary embodiments;

FIG. 4 is an isometric view of a seating bench of the seating system of FIG. 1, in accordance with exemplary embodiments;

FIGS. 5 and 6 are isometric views of a first engagement system of the seating system of FIG. 1, including a rotating cup of the rotating component and a stationary pin or trunnion of the base component, in accordance with exemplary embodiments;

FIGS. 7 and 8 are isometric views of a second engagement system of the seating system of FIG. 1, including a rod of the rotating component and a stationary bracket of the base component, in accordance with exemplary embodiments;

FIG. 9 is a schematic illustration of a locking mechanism for use as part of the seating system of FIG. 1, in accordance with exemplary embodiments;

FIG. 10 is a schematic illustration of the seating system of FIGS. 1-9, depicting with the rotating component in a seating position, in which an occupant may sit of the seating bench and the rotating component is locked into place, thereby preventing removal of the rotating component, in accordance with various embodiments;

FIG. 11 is a schematic illustration of the seating system of FIGS. 1-9, depicted with the rotating component in a stowed position, in which items may be stored in its place, and in which the rotating component is locked into place, thereby preventing removal of the rotating component, in accordance with various embodiments;

FIGS. 12-14 are schematic illustrations of the seating system of FIGS. 1-9, depicted with respect to various stages of removal of the rotating component when the rotating component is in an intermediate position, in which the rotating component may be readily removed without tools from the vehicle, in accordance with various embodiments;

FIG. 15 is a schematic illustration of the first engagement system of FIGS. 5 and 6, depicted in an unlocked position, in which a protruding member is aligned with an opening of a cup component, which thereby allows the rotating component to be installed or removed from this position; and

FIG. 16 is a schematic illustration of the first engagement system of FIGS. 5 and 6, depicted in a locked position, in which a protruding member is not aligned with an opening of a cup component, which thereby prevents the rotating component to be installed or removed from this position.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

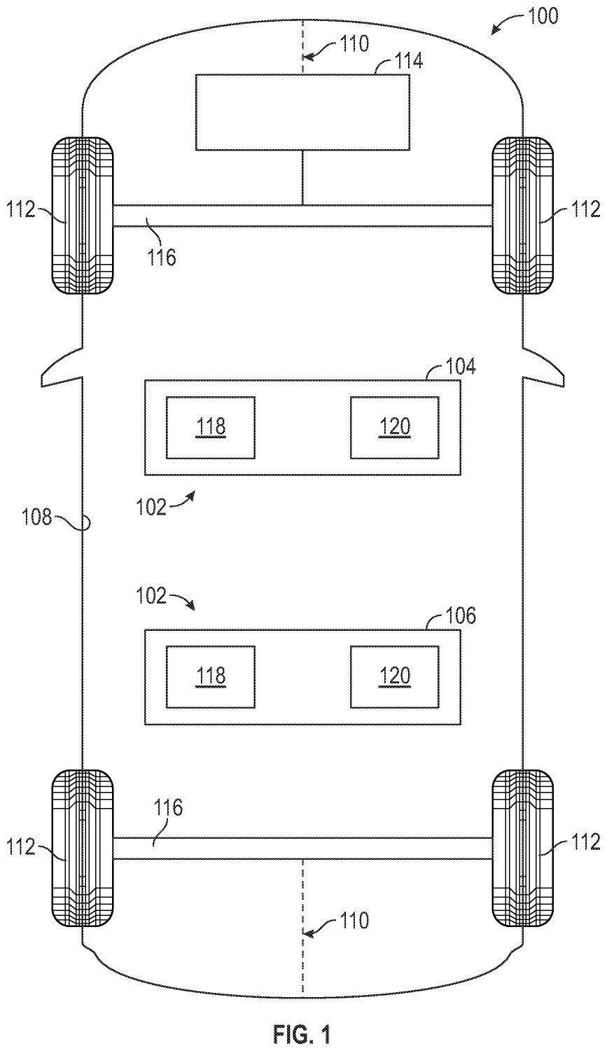

FIG. 1 illustrates a platform 100 having one or more seating systems 102, in accordance with exemplary embodiments. As described in greater detail below, each of the seating systems 102 includes a base component 118 and a rotating component 120 that is rotatable and readily removed when rotated to a certain angle, for example for removal from a vehicle or other platform, in accordance with exemplary embodiments

As depicted in FIG. 1, in certain embodiments, the platform 100 comprises a vehicle, such as an automobile. While the platform 100 may be hereafter referred to as a vehicle 100 (and depicted as an automobile in FIG. 1 and described below in connection therewith), it will be appreciated that the seating systems 102 described herein may be implemented in any number of different types of platforms 100. For example, in various embodiments, the platform 100 may comprise any number of different types of automobiles (e.g., taxi cabs, vehicle fleets, buses, sedans, wagons, trucks, sport utility vehicles, and other automobiles), other types of vehicles (e.g., marine vehicles, locomotives, aircraft, spacecraft, and other vehicles), other mobile platforms, buildings or rooms (e.g., bus stations, train stations, airports, offices, waiting rooms, and other buildings, rooms, or areas) and/or components thereof.

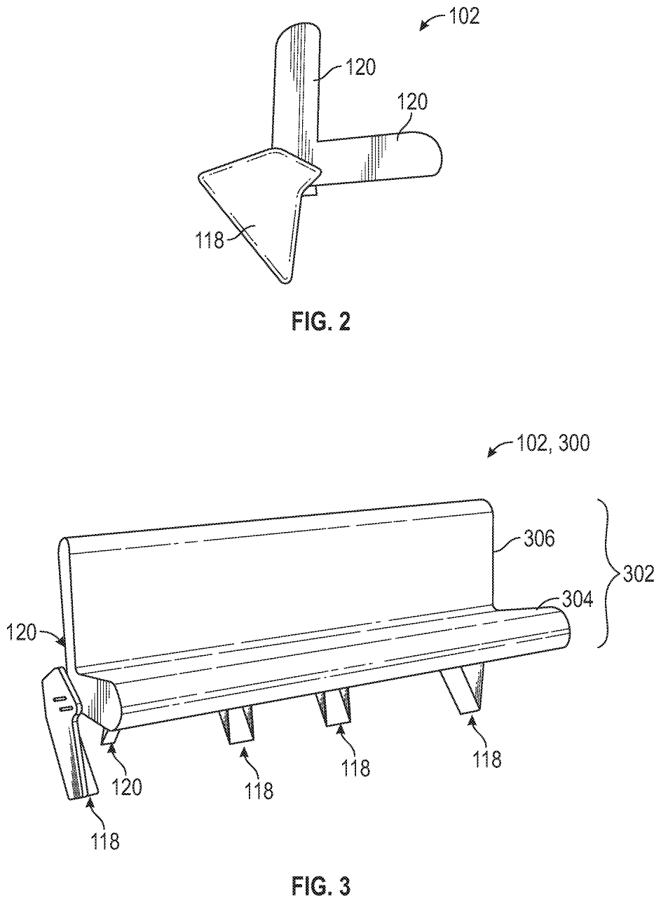

In the depicted embodiment, the vehicle 100 includes multiple seating systems 102, including a front seating system 104 (e.g., for a front row of passengers) and one or more rear seating systems 106 (e.g., for one or more rear rows of passengers). In certain embodiments, each seating system 102 comprises a seating bench for multiple occupants of a particular row of seating; however, this may vary in other embodiments. It will also be appreciated that the number and/or placement of the one or more seating systems 102 may vary in other embodiments, and that the system systems 102 may also be used in any number of different types of platforms, including vehicles and other types of platforms, for example as discussed above. In addition, as discussed in greater detail below in connection with FIG. 1 as well as in connection with FIGS. 2-16, in various embodiments each seating system 102 is configured to rotate and to be readily removable upon rotation to a certain angle.

In various embodiments, the vehicle 100 includes a body 108 that is arranged on a chassis 110. The body 108 substantially encloses other components of the vehicle 100. The body 108 and the chassis 110 may jointly form a frame. The vehicle 100 also includes a plurality of wheels 112. The wheels 112 are each rotationally coupled to the chassis 110 near a respective corner of the body 108 to facilitate movement of the vehicle 100. In one embodiment, the vehicle 100 includes four wheels 112, although this may vary in other embodiments (for example for trucks and certain other vehicles).

A drive system 114 is mounted on the chassis 110, and drives the wheels 112, for example via axles 116. The drive system 114 preferably comprises a propulsion system. In certain exemplary embodiments, the drive system 114 comprises an internal combustion engine and/or an electric motor/generator, coupled with a transmission thereof. In certain embodiments, the drive system 114 may vary, and/or two or more drive systems 110 may be used. By way of example, the vehicle 100 may also incorporate any one of, or combination of, a number of different types of propulsion systems, such as, for example, a gasoline or diesel fueled combustion engine, a “flex fuel vehicle” (FFV) engine (i.e., using a mixture of gasoline and alcohol), a gaseous compound (e.g., hydrogen and/or natural gas) fueled engine, a combustion/electric motor hybrid engine, and an electric motor.

As depicted in FIG. 1 and noted above, each seating system 102 includes a base component 118 and a rotating component 120. As described in greater detail below in connection with FIGS. 2-16, the rotating component 120 is rotatable between multiple positions. When the rotating component 120 is in a first position (i.e., a seating position), occupants may sit on a seating portion of the rotating component 120. When in a second position (i.e., a stowed position), the rotating component 120 is stowed, so that additional items may be stored in its place. When in a third position (i.e., an intermediate position), the rotating component 120 may be readily removed without tools from the vehicle 100. In addition, in various embodiments, the base component 118 does not rotate, and holds the rotating component 120 in place when the rotating component 120 is in the seating or stowed positions.

With reference to FIGS. 2-16, an exemplary seating system 102 is depicted with respect to various positions and angles, as described in greater detail below, in accordance with various embodiments. In certain embodiments, the seating system 102 of FIGS. 2-16 corresponds to either or both of the seating systems 102 of the vehicle 100 FIG. 1, and/or to one or more seating systems 102 of any number of other types of platforms, such as those noted above with respect to the discussion accompanying FIG. 1.

FIG. 2 is a side view of the seating system 102, in accordance with exemplary embodiments. Specifically, FIG. 2 provides a side view of the base component 118 and the rotating component 120 of the seating system 102. Similar to the discussion above, (i) when the rotating component 120 is in a first position (i.e., a seating position), occupants may sit on a seating portion of the rotating component 120; (ii) when the rotating component 120 is in a second position (i.e., a stowed position), the rotating component 120 is stowed, so that additional items may be stored in its place; and (iii) when the rotating component 120 is in a third position (i.e., an intermediate position), the rotating component 120 may be readily removed, for example from the vehicle 100 of FIG. 1. Also, as noted above, in various embodiments, the base component 118 does not rotate, and holds the rotating component 120 in place when the rotating component 120 is in the seating or stowed positions.

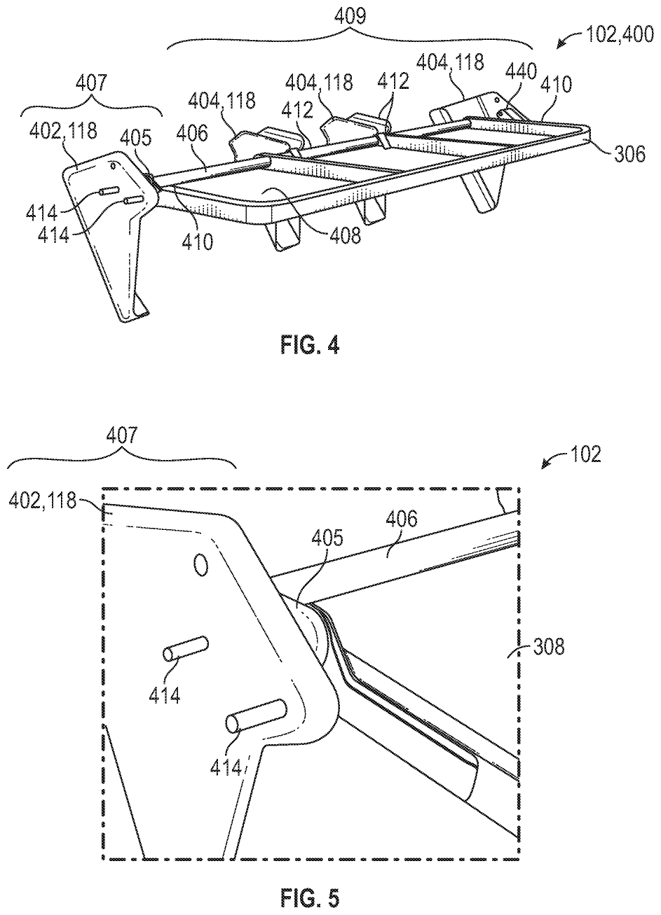

FIG. 3 is an isometric view of a front portion 300 of the seating system 102, in accordance with exemplary embodiments. As depicted in FIG. 3, the rotating component 120 includes a seating portion 302 having a seating bench 304. Also in certain embodiments, a backrest 306 remains stationary. In various embodiments, the seating bench 304 is attached or otherwise coupled to the remainder of the rotating component 120 (e.g., the pivot element 405 and the latchable element 406 depicted in FIG. 4 and described further below). In various embodiments one or both of the seating bench 304 and/or backrest 306 may be cushioned; however, this may vary in other embodiments.

In certain embodiments, when the rotating component 120 is in the seating position, the seating bench 304 is horizontal (or approximately horizontal) (e.g., with respect to a floor of the vehicle 100), while the backrest 306 is vertical (or approximately vertical) (e.g., with respect to a floor of the vehicle 100). Conversely, also in certain embodiments, when the rotating component 120 is in the stowed position, the seating bench 304 is vertical (or approximately vertical) (e.g., with respect to a floor of the vehicle 100), while the backrest 306 is horizontal (or approximately horizontal) (e.g., with respect to a floor of the vehicle 100). In addition, in certain embodiments, when the rotating component is in the intermediate position, the seating bench 304 are both disposed at intermediate angles (e.g., between zero and ninety degrees, with respect to the floor of the vehicle 100), and the rotating component 120 is readily removed from the vehicle 100. In certain embodiments, the intermediate angle is equal to (or approximately equal to) forty-five degrees with respect to the floor of the vehicle 100; however, this may vary in other embodiments.

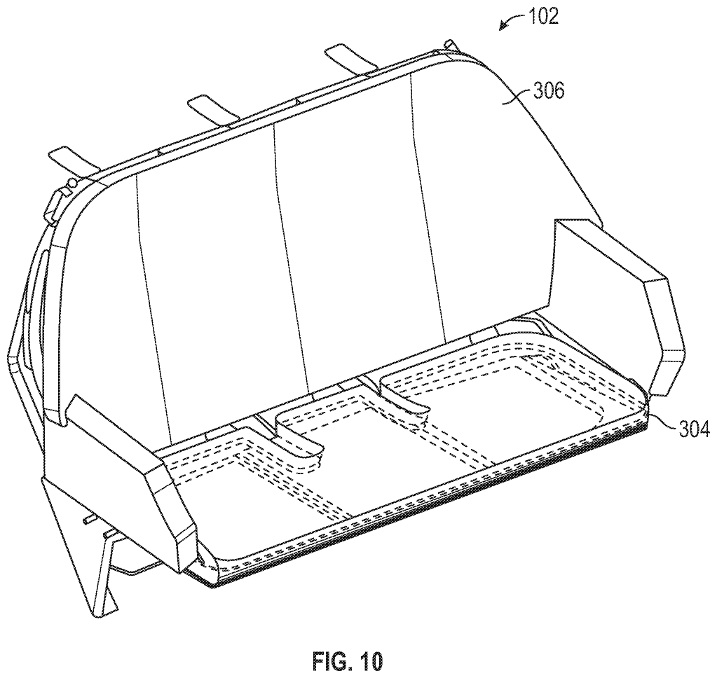

FIG. 10-14 are schematic illustrations of the seating system 102 of FIGS. 1-9, in accordance with various embodiments. The various illustrations of FIGS. 10-14 depict the positioning of the seating bench 304 and backrest 306 in various positions, along with removal of the seating bench 304.

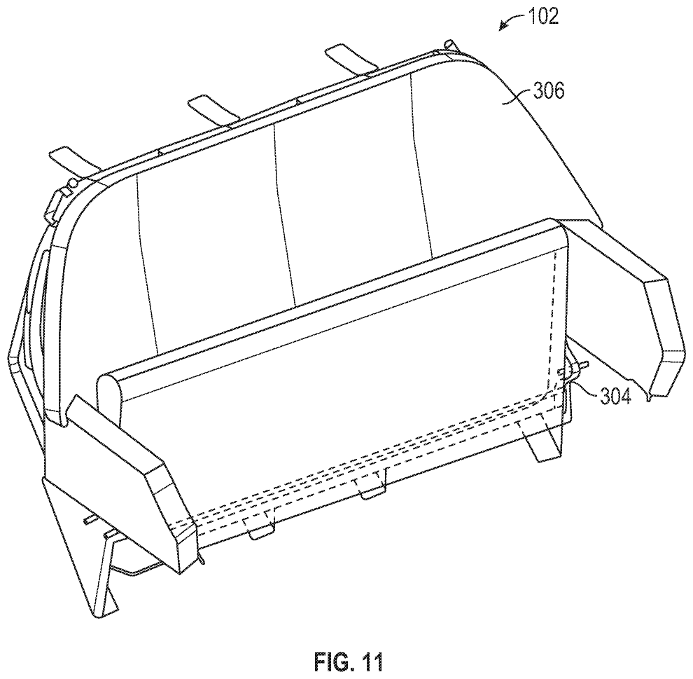

Specifically, FIG. 10 depicts the seating system 102 with the rotating component 120 in a seating position, in which an occupant may sit on the seating bench 304, and the rotating component 120 is locked into place, thereby preventing removal of the rotating component 120, in accordance with various embodiments. FIG. 11 depicts the seating system 102 with the rotating component 120 in a stowed position, in which items may be stored in its place, and in which the rotating component 120 is locked into place, thereby preventing removal of the rotating component 120, in accordance with various embodiments.

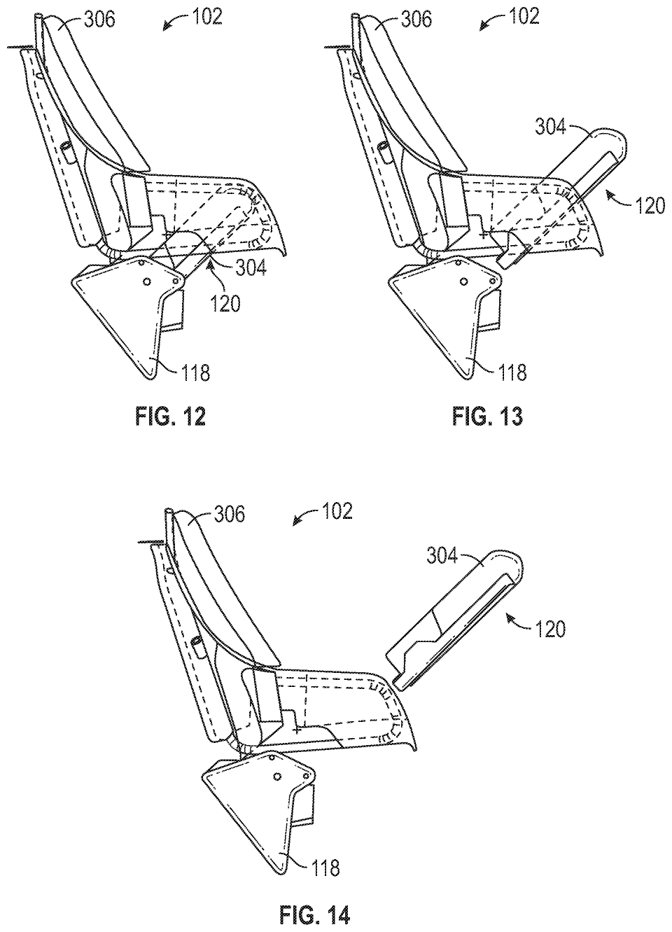

Moreover, FIGS. 12-14 depict the seating system 102 with respect to various stages of removal of the rotating component 120 when the rotating component 120 is in an intermediate position, in which the rotating component 120 may be readily removed without tools from the vehicle 100, in accordance with various embodiments. Specifically, (i) FIG. 12 depicts the rotating component 120 in the intermediate position, ready to be removed; (ii) FIG. 13 depicts the rotating component 120 as it is has begun to be removed (e.g., by an individual) from the intermediate position; and (iii) FIG. 14 depicts the rotating component 120 after it has been removed (e.g., by an individual) from the intermediate position.

FIG. 4 is an isometric view of a back portion 400 of the seating system 102, in accordance with exemplary embodiments. Specifically, as depicted in FIG. 4, in various embodiments, the base component 118 includes a housing 402 and a plurality of latching mechanisms 404, and the rotating component 120 includes a pivot element 405 and a latchable element 406. In various embodiments, the pivot element 405 and the latchable element 406 are both attached to or otherwise coupled to the seating portion 302 (i.e., to the seating bench 304 and/or the backrest 306).

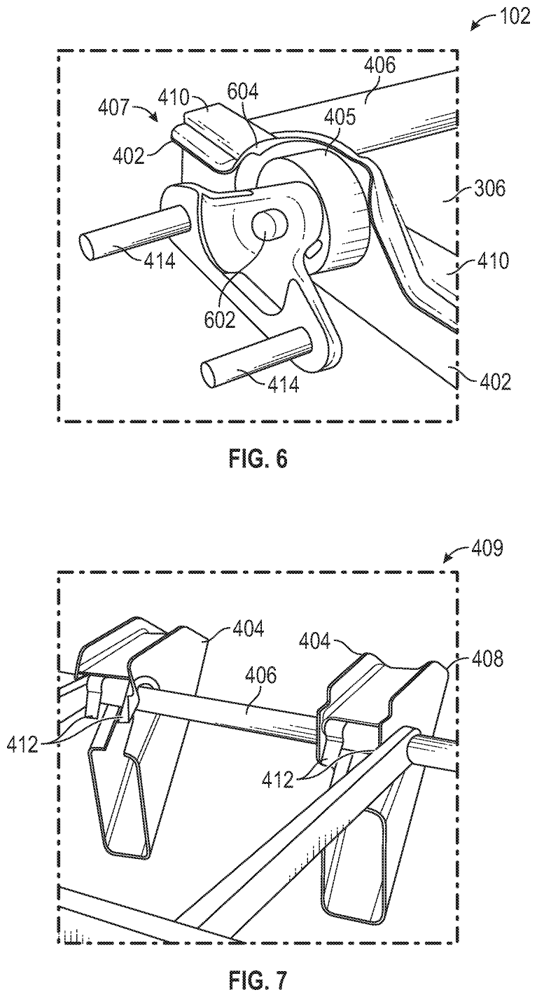

In various embodiments, the protruding member 602 and the pivot element 405 serve as mating components that, together, form a first engagement system 407. The first engagement system 407 helps to hold the rotating component 120 in place when the rotating component 120 is in the seating position or the stowed position, for example as discussed in greater detail further below in connection with FIGS. 5 and 6 and as also illustrated in FIGS. 10-16.

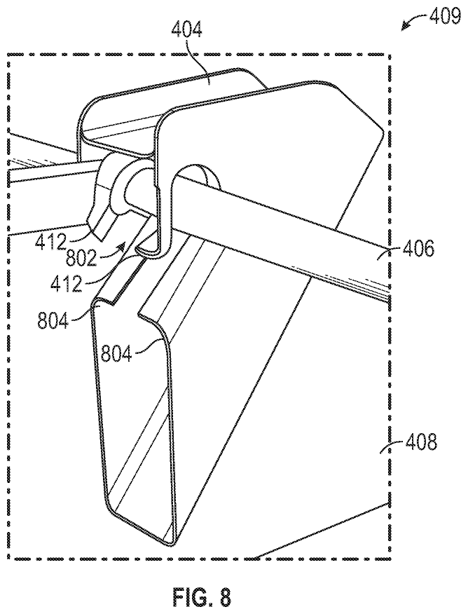

Also in various embodiments, the latching mechanisms 404 and the latchable element 406 serve as mating components that, together, form a second engagement system 409. The second engagement system 409, along with the first engagement system 407, also helps to hold the rotating component 120 in place when the rotating component 120 is in the seating position or the stowed position, for example as discussed in greater detail directly below in connection with FIG. 4 as well as further below in connection with FIGS. 7 and 8 and as also illustrated in FIGS. 10-16.

Specifically, in various embodiments, the latching mechanisms 404 collectively hold the latchable element 406 in place (to thereby help hold the rotating component 120 in place), when the rotating component 120 is in the seating position or the stowed position. As depicted in FIG. 4, in certain embodiments, the latchable element 406 comprises a rod that is attached to a back surface 408 of the backrest 306, and extends between a welded structure 410 that includes opposing ends of the backrest 306. Also in various embodiments, the latching mechanisms 404 comprise brackets with claws 412 having a curvature that holds the latchable element (e.g., rod) 406 into place (to thereby help hold the rotating component 120 in place) when the rotating component 120 is in the seating position and when the rotating component 120 is in the stowed position. In addition, also as depicted in FIG. 4, in various embodiments, attachment bolts 414 extend through the housing 402 for mounting to a floor mounting bracket of the vehicle 100 (or other platform).

FIGS. 5 and 6 are isometric views of the first engagement system 407, in accordance with exemplary embodiments. Specifically, (i) FIG. 5 is a first isometric view of a portion of the seating system 102 that includes the first engagement system 407 with the housing 402 intact; and (ii) FIG. 6 is a second isometric view of the same portion of the system 102 of FIG. 5, but with an exterior of the housing 402 removed for clarity.

As shown in FIGS. 5 and 6, in various embodiments, a protruding member 602 is disposed within the housing 402. In certain embodiments, the protruding member 602 is formed within the housing 402 and/or as part of the housing 402. In certain other embodiments, the protruding member 602 is attached to the housing 402. In certain embodiments, the protruding member 602 comprises a pin or trunnion with sufficient width so as to serve as a stop against the pivot element 405, to thereby prevent removal of the rotating component 120, when the rotating component 120 is in the seating position or the stowed position. In certain embodiments, the protruding member 602 comprises an oblong or elongated oval shaped pin or trunnion.

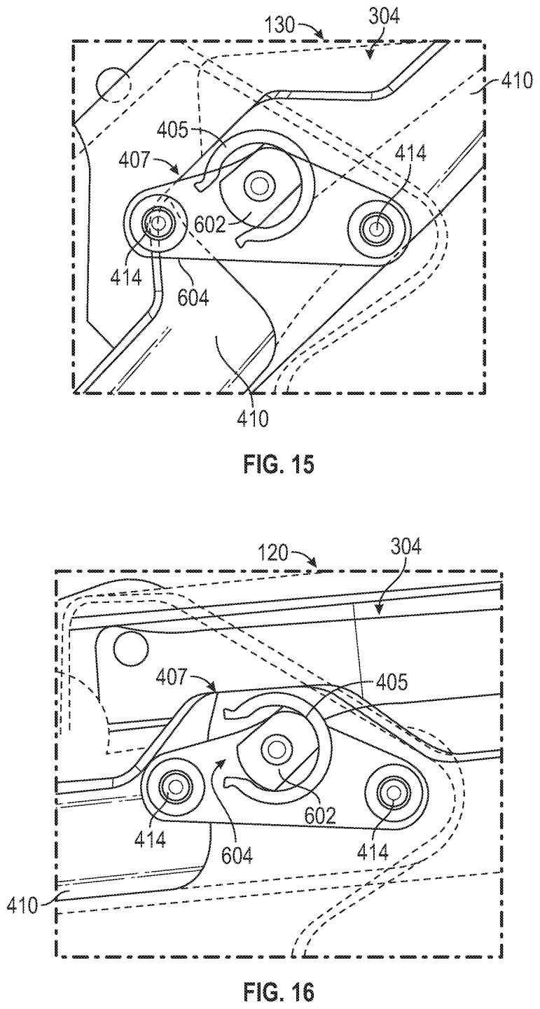

For example, with reference to FIGS. 15 and 16, additional illustrations are provided in accordance with various embodiments that show the first engagement system 407 in two different positions; namely: (i) an unlocked position (depicted in FIG. 15) and (ii) a locked position (depicted in FIG. 16). In various embodiments, the first engagement system 407 is in the unlocked position of FIG. 15 when the protruding member 602 is aligned with the opening 604 of the cup 405, which thereby allows the rotating component 120 to be installed or removed from this position. Conversely, in various embodiments, when the first engagement system 407 is in the locked position of FIG. 16 when the protruding member 602 is not aligned with the opening 604 of the cup 405, which thereby prevents the rotating component 120 to be installed or removed from this position. In addition, also as depicted in FIGS. 15 and 16, in various embodiments, the protruding member 602 (e.g., the pin and block assembly) is part of the welded seat structure 410 that includes opposing ends of the backrest, and ultimately the larger assembly of the first engagement system 407.

With continued reference to FIGS. 15 and 16 as well as FIGS. 5 and 6, in various embodiments, the pivot element 405 rotates around the protruding member 602. Also in various embodiments, the pivot element 405 is a substantially circular element with an opening 604. In various embodiments, the opening 604 is sufficiently large in comparison to the width of the pivot element 405 to allow the pivot element 405 to be removed from the protruding member 602, and to thereby allow removal of the rotating component 120 from the vehicle 100, when the rotating component is in the intermediate position (e.g., in certain embodiments, when the angle of the seating bench 304 with respect to a floor of the vehicle 100 is approximately forty-five degrees). Also in various embodiments, the opening 604 is also sufficiently small in comparison to the width of the pivot element 405 to not allow the pivot element 405 to be removed from the protruding member 602, and to thereby not allow removal of the rotating component 120 from the vehicle 100, when the rotating component 120 is in the seating position (e.g., in certain embodiments, when the angle of the seating bench 304 with respect to a floor of the vehicle 100 is approximately zero degrees) and when the rotating component 120 is in the stowed position (e.g., in certain embodiments, when the angle of the seating bench 304 with respect to a floor of the vehicle 100 is approximately ninety degrees). In addition, in certain embodiments, the size of the opening 604 in comparison to the width of the pivot element 405 provides that the pivot element 405 may be removed from the protruding member 602 (i.e., so that the rotating component 120 may be removed from the vehicle 100) only when the rotating component is in the intermediate position (e.g., such that the rotating component 120 may not be removed while the rotating component 120 is rotating between the three positions).

FIGS. 7 and 8 are isometric views of the second engagement system 409, in accordance with exemplary embodiments. Specifically, (i) FIG. 7 is a first isometric view of a portion of the second engagement system 409 while the rotating component 120 is in the seating position; and (ii) FIG. 8 is a second isometric view of a portion of the second engagement system 409 while the rotating component 120 is in the intermediate position.

As shown in FIG. 7, when the rotating component 120 is in the seating position, the latching mechanisms 404 hold the latchable element 406 in place, so that the rotating component 120 is not readily removable. Specifically, in various embodiments, the latching mechanisms 404 comprise brackets with claws 412 that hold rod 406 into place, and thereby holding the rotating component 120 into place (e.g., because the rod 406 is connected to the back surface 408 of the backrest 306). In various embodiments, the rod 406 (and thus the rotating component 120) is similarly held in place via the second engagement system 409 when the rotating component 120 is in the stowed position.

Conversely, as shown in FIG. 8, when the rotating component 120 is in the intermediate position, the latching mechanisms 404 do not hold the latchable element 406 in place. Rather, instead, in this position, the latchable element 406 is able to move away from the latching mechanisms through an opening 802 in the latching mechanism 404 that is disposed between the claws 412 and a lower body 804 of the latching mechanism 404. Accordingly, when the rotating component 120 is in the intermediate position, the rotating component 120 may be readily removed from the vehicle 100, for example by pulling the rotating component 120 away from the base component 118.

In various embodiments, the opening 802 of the latching mechanism 404 is (i) sufficiently large in comparison to the width (or diameter) of the latchable element 406 to allow the latchable element 406 to be removed from the latching mechanisms 404, and to thereby allow removal of the rotating component 120 from the vehicle 100, when the rotating component is in the intermediate position; and (ii) sufficiently small in comparison to the width (or diameter) of the latchable element 406 to not allow the latchable element 406 to be removed from the latching mechanisms 404, and to thereby not allow removal of the rotating component 120 from the vehicle 100, when the rotating component 120 is in the seating position or the stowed position. In addition, in certain embodiments, the size of the opening 802 in comparison to the width (or diameter) of the latchable element 406 provides that the latchable element 406 may be removed from the latching mechanisms 404 (i.e., so that the rotating component 120 may be removed from the vehicle 100), only when the rotating component is in the intermediate position (e.g., such that the rotating component 120 may not be removed while the rotating component 120 is rotating between the three positions).

Accordingly, in various embodiments, when the rotating component 120 is in either the seating or stowed positions, the rotating component 120 is held into place simultaneously by both the first engagement system 407 (e.g., with brackets 404 with claws 412 holding the rod 406 into place) and the second engagement system 409 (e.g., with the trunnion 602 holding the cup 405 into place). When the rotating component 120 is in the seated position, the weight of any occupants of the seating system 102 further helps to hold the rotating component 120 into place. The rotating component 120 can also be rotated between the seating and stowed positions by holding and rotating the seating bench 304 (e.g., between zero and ninety degrees) in various embodiments.

Also in various embodiments, when removal of the rotating component 120 is desired, the rotating component 120 may be rotated to the intermediate position. This can be accomplished, for example, by holding and rotating the seating bench 304 to an approximately forty-five-degree angle, in various embodiments. When the rotating component is in the intermediate position, the first and second engagement systems 407, 409 readily allow removal of the rotating component 120. Specifically, in various embodiments, when the rotating component 120 is in the intermediate position: (i) the opening 604 of the pivot element 405 is in position to allow movement of the pivot element 405 away from the protruding member 602; and, simultaneously, (ii) the openings 802 of the claws 412 allow movement of the latchable element 406 away from the latching mechanisms 404. As a result, when the rotating component 120 is in the intermediate position, a person can readily remove the rotating component 120 from the vehicle 100, for example by holding and pulling the seating bench 304 away from the base component 118.

Likewise, insertion of the rotating component 120 may be readily accomplished by a person by holding and rotating the seating bench 304 to the intermediate position and then pushing the seating bench 304 into the base component 118. Also, as discussed above, a person can readily rotate the rotating component 120 between the seating, stowed, and intermediate positions by holding and rotating the seating bench 304 to the angle corresponding to the desired position.

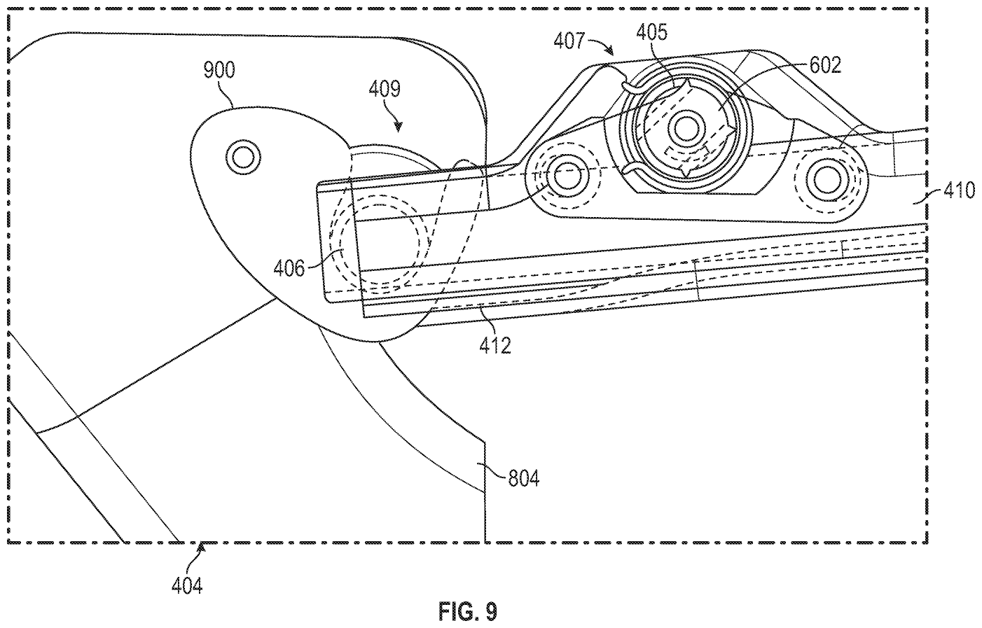

With reference to FIG. 9, in certain embodiments, the second engagement system 409 may also include a locking mechanism 900 for one or more of the latching mechanisms 404. Specifically, in certain embodiments, the locking mechanism 900 may serve as a latch on the outside of each of the latching mechanisms 404 (e.g., brackets), to thereby prevent removal of the latchable element 406 (e.g., rod) (and, thus, to prevent removal of the rotating component 120 as a whole). In certain embodiments, the locking mechanism may comprise a cushion rotating lock for the latching mechanism 404, for example as depicted in FIG. 9. In certain embodiments, such a locking mechanism 900 may be utilized so as to require a tool before removing the rotating component 120 from the vehicle 100. For example, in certain embodiments, the locking mechanism 900 may include a screw that requires a person to utilize a screwdriver for removal, and so on. In certain embodiments, one or more different types of locking mechanisms 404 may be utilized, such as a manual latch using cables, and electronic latch (e.g., similar to a door lock), and so on. In other embodiments, a locking mechanism 900 may not be utilized, so that a person may readily remove the rotating component 120 from the vehicle 100 without even requiring a tool.

Accordingly, the systems, vehicles, and other platforms described herein provide for a seating system that includes a base component as well as a rotating component. The rotating component is configured to be rotated between three positions; namely, a seating position, a stowed position, and an intermediate position. When in the seating position, occupants may sit on a seating portion of the seating system, as the removable component is held into place by first and second engagement systems. When in the stowed position, additional storage area is provided, and the removable component is still held into place by first and second engagement systems. When in the intermediate position, the removable component is readily removable from the vehicle (or other platform). In certain embodiments, a locking mechanism may also be utilized, for example to require a tool in order to remove the rotating component.

It will be appreciated that the systems, vehicles, and platforms may vary from those depicted in the Figures and described herein. It will similarly be appreciated that the seating system, and components and implementations thereof, may vary from that depicted in FIGS. 1-16 and described in connection therewith, in various embodiments.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A seating system comprising:
a base component that is fixed in position; and
a rotating component that is configured to rotate between:
a first position, in which one or more occupants may sit on the seating system; and
a second position, in which the rotating component may be readily removed from the seating system, without tools;
wherein the base component and the rotating have respective mating components forming one or more engagement systems that hold the rotating component into place when the rotating component is in the first position, and that allow removal of the rotating component when the rotating component is in the second position.

2. The seating system of claim 1, wherein:
the rotating component that is further configured to rotate to a third position, in which the rotating component is stowed; and
the one or more engagement systems also hold the rotating component into place when the rotating component is in the third position.

3. The seating system of claim 2, wherein the second position comprises an intermediate position between the first and third positions.

4. The seating system of claim 1, wherein:
the base component comprises a protruding element and a latching mechanism;
the rotating component comprises a pivot element and a latchable element;
the protruding element and the pivot element comprise first mating components that, together, form a first engagement system of the one or more engagement systems; and
the latching mechanism and the latchable element comprise second mating component that, together, form a second engagement system of the one or more engagement systems.

5. The seating system of claim 2, wherein the rotating component further comprises a seating region that is attached or otherwise coupled to the pivot element and the latchable element.

6. The seating system of claim 5, wherein the seating region comprises a seating bench and a backrest that are attached or otherwise coupled to one another.

7. The seating system of claim 6, wherein:
the pivot element comprises a cup-shaped element;
the protruding element comprises a pin;
the latching mechanism comprises a bracket with a claw; and
the latchable element comprises a rod.

8. The seating system of claim 7, further comprising:
a latch for the bracket that requires a mechanical means of release to adjust the seat to another one of the first, second, or third positions.

9. The seating system of claim 7, wherein the seating system is configured for installation within a vehicle.

10. A seating system for installation within a platform, the seating system comprising:
a base component that is fixed in position and that comprises:
a latching mechanism; and
a protruding element; and
a rotating component that is configured to rotate between:
a seating position, in which one or more occupants may sit on the seating system,
a stowed position, in which the rotating component is stowed; and
an intermediate position, in which the rotating component may be readily removed from the seating system;
the rotating component comprising:
a seating region;
a latchable element that is attached or otherwise coupled to the seating region; and
a pivot element that is attached or otherwise coupled to the seating region;
wherein:
the latching mechanism and the latchable element are mating components that, collectively, comprise a first engagement system that holds the rotating component into place when the rotating component is in the seating position and when the rotating component is in the stowed position; and
the pivot element and the protruding element are mating components that, collectively, comprise a second engagement system that also holds the rotating component into place when the rotating component is in the seating position and when the rotating component is in the stowed position.

11. The seating system of claim 10, wherein the seating region comprises a seating bench and a backrest that are attached or otherwise coupled to one another.

12. The seating system of claim 11, wherein:
the pivot element comprises a cup-shaped element;
the protruding element comprises a pin;
the latching mechanism comprises a bracket with a claw; and
the latchable element comprises a rod.

13. The seating system of claim 12, further comprising:
a latch for the bracket that requires a mechanical means of release to adjust the seat to another one of the 3 positions.

14. The seating system of claim 13, wherein the seating system is configured for installation within a vehicle.

15. A platform comprising:
a body; and
a seating system disposed within the body, the seating system comprising:
a base component that is fixed in position and that comprises:
a latching mechanism; and
a protruding element; and
a rotating component that is configured to rotate between:
a seating position, in which one or more occupants may sit on the seating system,
a stowed position, in which the rotating component is stowed; and
an intermediate position, in which the rotating component may be readily removed from the seating system;
the rotating component comprising:
a seating region;
a latchable element that is attached or otherwise coupled to the seating region; and
a pivot element that is attached or otherwise coupled to the seating region;
wherein:
the latching mechanism and the latchable element are mating components that, collectively, comprise a first engagement system that holds the rotating component into place when the rotating component is in the seating position and when the rotating component is in the stowed position; and
the pivot element and the protruding element are mating components that, collectively, comprise a second engagement system that also holds the rotating component into place when the rotating component is in the seating position and when the rotating component is in the stowed position.

16. The platform of claim 15, wherein the seating region comprises a seating bench and a backrest that are attached or otherwise coupled to one another.

17. The platform of claim 16, wherein:
the pivot element comprises a cup-shaped element;
the protruding element comprises a pin;
the latching mechanism comprises a bracket with a claw; and
the latchable element comprises a rod.

18. The platform of claim 17, further comprising:
a latch for the bracket that requires a tool for removal of the rotating component.

19. The platform of claim 17, wherein the platform comprises a mobile platform.

20. The platform of claim 19, wherein the mobile platform comprises an automotive vehicle.
